(19) United States
(12) Patent Application Publication
(10) Pub. No.: US 2011/0157388 A1
(43) Pub. Date: Jun. 30, 2011

(54) Gun Camera

(75) Inventor: Ming-Yen Liu, Taipei City (TW)

(73) Assignee: Jiun An Technology Co., Ltd.

(21) Appl. No.: 11/905,396

(22) Filed: Sep. 28, 2007

(30) Foreign Application Priority Data
Feb. 7, 2007 (TW) 096202340

(51) Int. Cl. H04N 5/228

(52) U.S. Cl. 348/222.1; 348/E05.031

(57) ABSTRACT

A gun camera, including a main body, a video unit, a video processing unit, a recording unit and a power supply unit, wherein interior of the main body forms a holding space, and the main body can be separably joined to a gun device. The video unit fixed to the main body is used to convert external video images into electronic signals. The video processing unit fixedly positioned within the main body processes and converts electronic signals produced by the video unit into digital video data. The recording unit electrically connected to the video processing unit is used to store the digital video data, and the power supply unit provides the electric power required by the video unit, the video processing unit and the recording unit. Accordingly: the gun camera is operated in coordination with a gun device or manually operated to implement immediate filming and recording of video.

### BACKGROUND OF THE INVENTION

(a) Field of the Invention

The present invention relates to cameras, and more particularly to a gun camera which can be attached to an electric gun and a common handgun or rifle to implement immediate video recording.

(b) Description of the Prior Art

Electric guns or military and police firearms are but some of the instruments usually worn when military duties, police services or general security services are carried out or during gunnery training. However, when using such instruments, because there is the possibility of impinging upon the body of other people, thus, both the occasion for use and the important criteria for use come under extremely strict operational guidelines. Nevertheless, because use of such instruments is often when dealing with an urgent situation, the elapsed time of use passes by in a flash. Moreover, after the event, a review of the occasion for use or method of use must be carried out, and if the course of the event is to be understood, unless there was a third party to act as witness or the event was recorded, otherwise, normally only the user is able to explain the course of events during use of the instrument, and without an actual video recording that can be analyzed to understand the course of events, analysis of the use of instruments or collecting criminal evidence becomes inconvenient.

### SUMMARY OF THE INVENTION

Accordingly, a primary objective of the present invention is to provide a gun camera which can be attached to an electric gun and a common handgun or rifle to implement immediate video recording.

In order to achieve the aforementioned objectives, the gun camera of the present invention comprises a main body, a video unit, a video processing unit, a recording unit and a power supply unit. Interior of the main body forms a holding space, and the main body can be separably joined to a gun device. The video unit is fixed to the main body, and is used to convert external video images into electronic signals. The video processing unit is fixedly positioned within the main body, wherewith arithmetic processing of electronic signals produced by the video unit is converted into digital video data. The recording unit is electrically connected to the video processing unit, and is used to store the digital video data, and the power supply unit provides the electric power required by the video unit, the video processing unit and the recording unit. Accordingly: the gun camera is operated in coordination with a gun device or manually operated to implement immediate filming and recording of video.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view of a preferred embodiment of a gun camera in use according to the present invention.

FIG. 2 shows a top schematic view depicting the structure of the preferred embodiment according to the present invention.

FIG. 3 shows a bottom schematic view depicting the structure of the preferred embodiment according to the present invention.

### DETAILED DESCRIPTION OF THE PREFERRED EMBODIMENTS

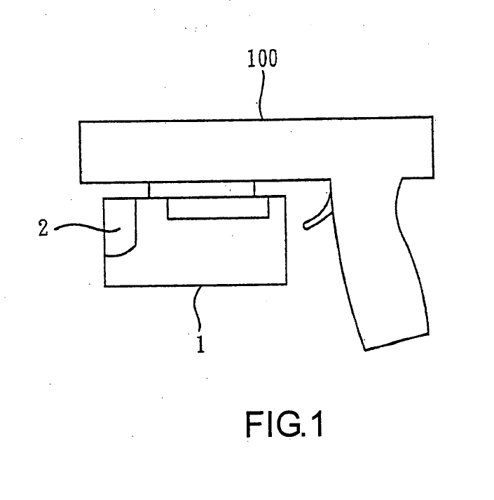

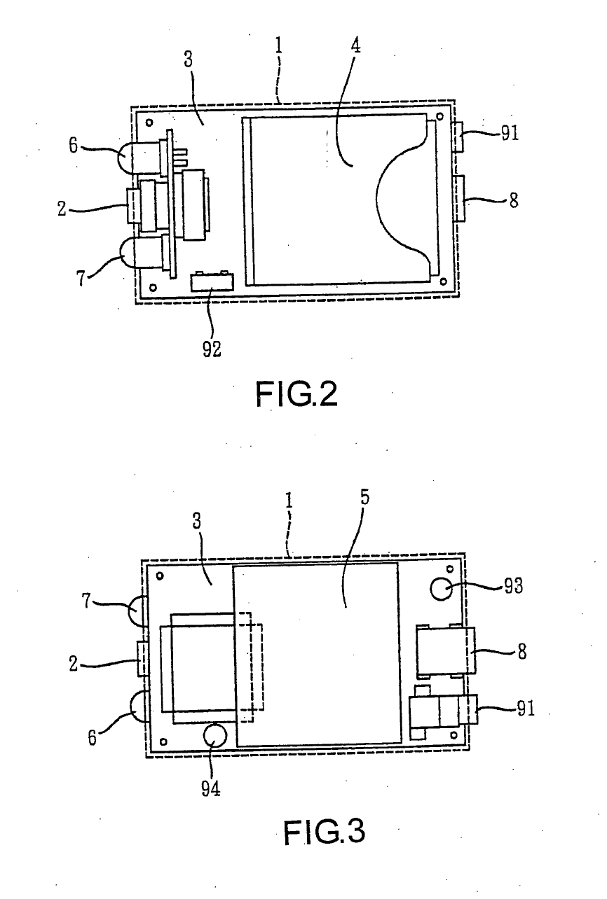

Referring to FIGS. 1, 2 and 3, a preferred embodiment of a gun camera of the present invention comprises a main body 1, a video unit 2, an video processing unit 3, a recording unit 4 and a power supply unit 5, wherein the gun camera is attached to a gun device 100: The gun device 100 can be an electric gun, and can also be a common firearm, including a pistol or a rifle, however, application range of the present invention is not limited to such devices.

The main body 1 is a housing, interior of which forms a holding space, and can be separably joined to the gun device 100, wherein the joining method employed can be any fixing method, including a clamping method, screw method, and the like. If used in conjunction with a sight tactical rail, then the main body 1 can be joined to various types of long and short-barreled firearms.

The video unit 2 is fixed to the main body 1, and in the preferred embodiment of the present invention, the video unit 2 is a CCD (charge coupled device) camera lens, wherewith external video images are converted into electronic signals. If additionally configured with a microphone (not shown in the drawings), then sound can be also converted into electronic signals.

The video processing unit 3 is fixedly positioned within the main body 1, and in the preferred embodiment of the present invention, the video processing unit 3 is a microprocessor which is configured together with an essential electric circuit to constitute an electric circuit device, wherewith arithmetic processing of electronic signals produced by the video unit 2 are converted into digital video data (which may include digital sound data).

The recording unit 4 is electrically connected to the video processing unit 3, and in the preferred embodiment of the present invention, the recording unit 4 is a memory card, for example, an SD memory card, and the like, which is used to store the digital video data.

The power supply unit 5 is a rechargeable battery that can be detached and replaced, and which provides the electric power required by the video unit 2, the video processing unit 3 and the recording unit 4.

In addition, the gun camera may be configured with a auxiliary light unit 6, a light guide unit 7 and an output unit 8, wherein the auxiliary light unit 6 is able to produce an illuminating light source using the electric power provided by the power supply unit 5, thereby facilitating the video unit 2 in the formation of video images. The auxiliary light unit 6 is preferably an infrared light-emitting diode (IR LED), which can be used for night vision video recording. Moreover, the light guide unit 7 is a laser beam producing device which provides an aiming reference for the gun device 100. The output unit 8 can be an electric connector, which is used to output the digital video data; and if a universal serial bus (USB) electric connector is adopted, then it enables electrical connection to an external device conforming to USB specifications, and, furthermore, enables connection to an external power supply and charging of the corresponding rechargeable battery of the power supply unit 5.

Using the aforementioned structure in conjunction with an electric gun as an example, the gun camera is able to directly use a direct current electrical connector 91 to connect to the power supply of the electric gun having a voltage range between 6V and 9V, and thus maintain charging of the power supply unit when the electric gun is not being used. However, when the electric gun enters a standby attack mode, then a safety switch is switched on, which automatically activates video recording, and the video unit 2 records video images (which may include sound) pointed at by the electric gun within the recording unit 4 through the video processing unit 3. When necessary, the gun camera can be used in conjunction with the auxiliary light unit 6 and the light guide unit 7 to implement night vision, supplement lighting or for aiming, thereby achieving the objective of immediate video recording.

Moreover, if the gun camera is separated from the electric gun or connected to other firearms, then the rechargeable battery of the power supply unit 5 can be used to supply power. In addition, a manual button 92 can be further installed, which is used to manually control activation of video recording. In the embodiment of the present invention, the manual button 92 is designed as a two stage slide button, in which the first stage is used to open the auxiliary light unit 6, and the second stage then activates video recording, operating means of which is the same as that described above, and thus not further detailed herein. Furthermore, a red green two-color LED indicator light 93 can be disposed on the main body 1, wherewith a continuous red light indicates that the gun camera is in the process of video recording; a flashing red light indicates that the recording unit 4 is full, a flashing green light indicates that the gun camera is undergoing charging via an external power supply and a continuous green light indicates that the rechargeable battery is fully charged. In addition, the main body 1 can be further designed with a main supply switch 94, which is used to control whether or not power is being supplied to the entire gun camera.

In conclusion, the gun camera of the present invention in using the aforementioned structure has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A gun camera, which can be attached to a gun device, wherein the gun camera comprises:
a main body, interior of which forms a holding space, and the main body is separably joined to a gun device;
a video unit, the video unit being fixed to the main body and used to convert external video images into electronic signals;
a video processing unit, the video processing unit being fixedly positioned within the main body, wherewith arithmetic processing of electronic signals produced by the video unit are converted into digital video data;
a recording unit, the recording unit being electrically connected to the video processing unit and used to store the digital video data;
a power supply unit, which provides the electric power required by the video unit, the video processing unit and the recording unit.

2. The gun camera according to claim 1, further comprising an auxiliary light unit, which is able to produce an illuminating light source using the electric power provided by the power supply unit, thereby facilitating the video unit in the formation of video images.

3. The gun camera according to claim 1, further comprising a light guide unit, which produces a light beam to provide an aiming reference for a gun device.

4. The gun camera according to claim 1, further comprising an output unit, which is used to output the digital video data.

5. The gun camera according to claim 1, wherein the video unit is a CCD (charge coupled device) camera lens.

6. The gun camera according to claim 1, wherein the recording unit is a memory card.

7. The gun camera according to claim 1, wherein the power supply unit is a rechargeable battery.

8. The gun camera according to claim 2, wherein the auxiliary light unit is an infrared light-emitting diode (IR LED).

9. The gun camera according to claim 3, wherein the light guide unit is a laser beam producing device.

10. The gun camera according to claim 4, wherein the output unit is a universal serial bus (USB) electric connector, which enables electrical connection to an external device.
